(19) United States
(12) Patent Application Publication
(10) Pub. No.: US 2024/0150228 A1
(43) Pub. Date: May 9, 2024

(54) METHOD FOR PRODUCING A MINERAL FIBRE PRODUCT

(71) Applicant: ROCKWOOL A/S, Hedehusene (DK)

(72) Inventor: Thomas Hjelmgaard, Hedehusene (DK)

(21) Appl. No.: 18/277,518

(22) PCT Filed: Feb. 16, 2021
(86) PCT No.: PCT/EP2021/053799

§ 371 Date: Aug. 16, 2023

(51) Int. Cl. C03C 13/06; C03C 25/002; C03C 25/40

(52) U.S. Cl. CPC C03C 13/06; C03C 25/002; C03C 25/40

(57) ABSTRACT

A method for producing a mineral wool product includes contacting mineral fibres with a formaldehyde-free binder composition for mineral fibres.

### CROSS-REFERENCE TO RELATED APPLICATIONS

This application is the U.S. National Stage of PCT/EP2021/053799 filed on Feb. 16, 2021, the entire content of is incorporated herein by reference in its entirety.

### FIELD OF THE INVENTION

The present invention relates to a method of producing a mineral wool product which comprises the step of contacting mineral fibres with a binder composition, and a mineral wool product prepared by the method. The present invention further relates to a mineral wool product characterized by a low water absorption and the use of a curing step in a certain temperature range in a method for producing a mineral wool product.

### BACKGROUND OF THE INVENTION

Mineral wool products generally comprise man-made vitreous fibres (MMVF) such as, e.g., glass fibres, ceramic fibres, basalt fibres, slag wool, mineral wool and stone wool (rock wool), which are bonded together by a cured thermoset polymeric binder material. For use as thermal or acoustical insulation products, bonded mineral fibre mats are generally produced by converting a melt made of suitable raw materials to fibres in conventional manner, for instance by a spinning cup process or by a cascade rotor process. The fibres are blown into a forming chamber and, while airborne and while still hot, are sprayed with a binder solution and randomly deposited as a mat or web onto a travelling conveyor. The fibre mat is then transferred to a curing oven where heated air is blown through the mat to cure the binder and rigidly bond the mineral fibres together.

In the past, the binder resins of choice have been phenol-formaldehyde resins which can be economically produced and can be extended with urea prior to use as a binder. However, the existing and proposed legislation directed to the lowering or elimination of formaldehyde emissions have led to the development of formaldehyde-free binders such as, for instance, the binder compositions based on polycarboxy polymers and polyols or polyamines, such as disclosed in EP-A-583086, EP-A-990727, EP-A-1741726, U.S. Pat. No. 5,318,990 and US-A-2007/0173588.

Another group of non-phenol-formaldehyde binders are the addition/-elimination reaction products of aliphatic and/or aromatic anhydrides with alkanolamines, e.g., as disclosed in WO 99/36368, WO 01/05725, WO 01/96460, WO 02/06178, WO 2004/007615 and WO 2006/061249. These binder compositions are water soluble and exhibit excellent binding properties in terms of curing speed and curing density. WO 2008/023032 discloses urea-modified binders of that type, which provide mineral wool products having reduced moisture take-up.

Since some of the starting materials used in the production of these binders are rather expensive chemicals, there is an ongoing need to provide formaldehyde-free binders, which are economically produced.

A further effect in connection with previously known aqueous binder compositions for mineral fibres is that at least the majority of the starting materials used for the productions of these binders stem from fossil fuels. There is an ongoing trend of consumers to prefer products that are fully or at least partly produced from renewable materials and there is therefore a need to provide binders for mineral wool, which are at least partly produced from renewable materials.

A further effect in connection with previously known aqueous binder compositions for mineral fibres is that they involve components, which are corrosive and/or harmful. This requires protective measures for the machinery involved in the production of mineral wool products to prevent corrosion and also requires safety measures for the persons handling this machinery. This leads to increased costs and health issues and there is therefore a need to provide binder compositions for mineral fibres with a reduced content of corrosive and/or harmful materials.

Such aqueous binder compositions are used in methods for preparing mineral wool products by applying the aqueous binder compositions to mineral fibres.

Many different compositions have been proposed for mineral wool binders at least partly produced from renewable materials. Proteins have been proposed as one possible component for such mineral wool binders. While mineral wool binders comprising proteins as a renewable material show excellent properties, it has been found that mineral wool binders comprising proteins as a main component, in particular mineral wool binders comprising proteins in an amount of ≥35 wt.-%, based on the total binder component solids, can lead to an increased water uptake of mineral wool products prepared from those binders.

Another important factor in these methods, apart from the aqueous binder used, is the curing temperature used in the method.

Generally, low curing temperatures are desirable, because they allow inexpensive curing equipment and a low energy consumption during the curing process, both of which are economically advantageous. Another advantage of applying low curing temperatures is that they are expected to result in lower emission of harmful gases during the curing process which again allows for less costly equipment to be used in the curing process.

On the other hand, high curing temperatures allow for relatively fast curing times and a relatively high completion of the curing process, which is expected to result in good mechanical properties, and also have a lower water absorption.

Accordingly, there is still a need to provide a method for preparing mineral wool products, which employs an aqueous binder composition prepared to a large part from renewable materials which are not corrosive or harmful and in the process of which only a small amount of harmful gases are produced and at the same time the mineral wool product resulting from the curing has very good mechanical properties as well as low water absorption.

### SUMMARY OF THE INVENTION

Accordingly, it was an object of the present invention to provide a method for preparing a mineral wool product which comprise the step of contacting mineral fibres with a binder composition for mineral fibres which uses renewable materials as starting materials and reduces or eliminates corrosive and/or harmful materials, minimizes harmful emissions during the curing process and at the same time allow improved properties of the mineral wool products produced by the method, and at the same time allow for a low water absorption.

Further, it was an objection of the present invention to provide a mineral wool product prepared by this method.

In accordance with a first aspect of the present invention, there is provided a method for producing a mineral wool product, which comprises the step of contacting mineral fibres with a formaldehyde-free binder composition for mineral fibres comprising:
at least one protein in an amount of ≥35 wt.-%, such as ≥40 wt.-%, such as 50 wt.-%, such as ≥70 wt.-%, based on the weight of the total binder component solids, and
at least one additive selected from the group consisting of silicone oils, silicone resins, mineral oils, plant oils, hydrolysed plant oils, paraffins, waxes, superhydrofobic coatings such as nano-particles, and any mixtures thereof,
and curing the binder composition at a temperature of 150° C.-250° C., such as >150° C.-250° C., such as 175° C.-225° C.

The present inventors have surprisingly found that they were able to provide a previously unknown mineral wool product, namely a mineral wool product that is characterized in that it is bound by a cured formaldehyde-free binder, wherein the binder in its uncured state comprises at least one protein in an amount of ≥35 wt.-% and at the same time has a water absorption of ≤5 kg/m², such as ≤2 kg/m², such as ≤1 kg/m².

In accordance with a second aspect of the present invention, there is provided a mineral wool product produced by this method.

The present inventors have surprisingly found that it is possible to provide a method for producing a mineral wool product which uses a binder composition prepared from renewable materials in the form of proteins and allows for a curing step in a specific temperature range which enables very low emissions during the curing process and at the same time achieves excellent mechanical properties of the resulting mineral wool product, and at the same time allows for low water absorption properties.

The present inventors have surprisingly found that the disadvantages which can in some cases be found that the water uptake properties of mineral wool products prepared from protein based binders can be drastically improved by implementing the combination of including the addition of additives selected from the group consisting of silicone oils and silicone resins, and any mixtures thereof in the binder used to prepare the mineral wool product and by conducting the step of curing in the method of producing the mineral wool product such that the curing temperatures are between 130° C.-250° C., such as 130° C.-225° C., such as ≥130° C.-225° C., such as 150° C.-220° C. It was surprising and previously unknown that by choosing this specific temperature range for the curing step and including these specific additives in the binders, this strong improvement in the water absorption properties of mineral wool products could be achieved.

Further, the present inventors have found that when using the curing temperature described above in the curing step, it is easier to carry out the curing step in an online process when compared to a curing step conducted at lower temperature like e.g. room temperature.

For the purpose of the present application, the term “formaldehyde free” is defined to characterize a mineral wool product where the emission is below 5 μg/m²/h of formaldehyde from the mineral wool product, preferably below 3 μg/m²/h. Preferably, the test is carried out in accordance with ISO 16000 for testing aldehyde emissions.

### DESCRIPTION OF THE PREFERRED EMBODIMENTS

The present invention is directed to method for producing a mineral wool product, which comprises the step of contacting mineral fibres with a formaldehyde-free binder composition for mineral fibres comprising:
at least one protein in an amount of ≥35 wt.-%, such as ≥40 wt.-%, such as 50 wt.-%, such as ≥70 wt.-%, based on the weight of the total binder component solids, and
at least one additive selected from the group consisting of silicone oils, silicone resins, mineral oils, plant oils, hydrolysed plant oils, paraffins, waxes, superhydrofobic coatings such as nano-particles, and any mixtures thereof,
and curing the binder composition at a temperature of 150° C.-250° C., such as ≥150° C.-250° C., such as 175° C.-225° C.

The present invention is also directed to a mineral wool product comprising mineral fibres bound by a cured binder, wherein
the binder in its uncured state comprises
at least one protein in an amount of ≥35 wt.-%, such as ≥40 wt.-%, such as 50 wt.-%, such as ≥70 wt.-%, based on the weight of the total binder component solids, and
at least one additive selected from the group consisting of silicone oils, silicone resins, mineral oils, plant oils, hydrolysed plant oils, paraffins, waxes, superhydrofobic coatings such as nano-particles, and any mixtures thereof,
and the mineral wool product has a water absorption of ≤5 kg/m², such as ≤2 kg/m², such as ≤1 kg/m².

In a preferred embodiment, the method according to the present invention comprises the step of applying a formaldehyde-free binder composition.

For the purpose of the present application, the term “formaldehyde free” is defined to characterize a mineral wool product where the emission is below 5 μg/m²/h of formaldehyde from the mineral wool product, preferably below 3 μg/m²/h. Preferably, the test is carried out in accordance with ISO 16000 for testing aldehyde emissions.

The present inventors have surprisingly found that by employing the temperature range 150° C.-250° C., such as ≥150° C.-250° C., such as 175° C.-225° C. for the curing step in the method according to the present invention, a very advantageous combination of features of fast curing, low emission of harmful gases during the curing process and excellent mechanical properties of the mineral wool product resulting from the method can be achieved, and at the same time the water absorption properties can be strongly improved when compared to previously known wool products prepared with protein based binders.

In one embodiment, the present invention is directed to a method which comprises the steps of:
making a melt of raw materials,
fibrerising the melt by means of a fibre forming apparatus to form mineral fibres,
providing the mineral fibres in the form of a collected web,
mixing the binder composition with the mineral fibres before, during or after the proviso of the collected web to form a mixture of mineral fibres and binder,
and curing the mixture of mineral fibres and binder.

Protein Component of the Binder

Preferably, the protein component of the binder is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin; proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; polyphenolic proteins such as mussel foot protein.

Collagen is a very abundant material in living tissue: It is the main component in connective tissue and constitutes 25-35% of the total protein content in mammals. Gelatin is derived from chemical degradation of collagen. Gelatin may also be produced by recombinant techniques. Gelatin is water soluble and has a molecular weight of 10.000 to 500.000 g/mol, such as 30.000 to 300.000 g/mol dependent on the grade of hydrolysis.

Gelatin is a widely used food product and it is therefore generally accepted that this compound is totally non-toxic and therefore no precautions are to be taken when handling gelatin.

Gelatin is a heterogeneous mixture of single or multi-stranded polypeptides, typically showing helix structures. Specifically, the triple helix of type I collagen extracted from skin and bones, as a source for gelatin, is composed of two α1(I) and one α2(I) chains.

Gelatin solutions may undergo coil-helix transitions.

A type gelatins are produced by acidic treatment. B type gelatins are produced by basic treatment.

Chemical cross-links may be introduced to gelatin. In one embodiment, transglutaminase is used to link lysine to glutamine residues; in one embodiment,

glutaraldehyde is used to link lysine to lysine, in one embodiment, tannins are used to link lysine residues.

The gelatin can also be further hydrolysed to smaller fragments of down to 3000 g/mol.

On cooling a gelatin solution, collagen like helices may be formed. Gelatin may form helix structures.

In one embodiment, the cured binder comprising protein comprises helix structures.

In one embodiment, the at least one protein is a low strength gelatin, such as a gelatin having a gel strength of 30 to 125 Bloom.

In one embodiment, the at least one protein is a medium strength gelatin, such as a gelatin having a gel strength of 125 to 180 Bloom.

In one embodiment, the at least one protein is a high strength gelatin, such as a gelatin having a gel strength of 180 to 300 Bloom.

In a preferred embodiment, the gelatin is preferably originating from one or more sources from the group consisting of mammal, bird species, such as from cow, pig, horse, fowl, and/or from scales, skin of fish.

In one embodiment, urea may be added to the binder compositions according to the present invention. The inventors have found that the addition of even small amounts of urea causes denaturation of the gelatin, which can slow down the gelling, which might be desired in some embodiments. The addition of urea might also lead to a softening of the product.

The inventors have found that the carboxylic acid groups in gelatins interact strongly with trivalent and tetravalent ions, for example aluminum salts. This is especially true for type B gelatins which contain more carboxylic acid groups than type A gelatins.

The present inventors have found that in some embodiments, curing/drying of binder compositions according to the present invention including gelatin should not start off at very high temperatures.

The inventors have found that starting the curing at low temperatures may lead to stronger products. Without being bound to any particular theory, it is assumed by the inventors that starting curing at high temperatures may lead to an impenetrable outer shell of the binder composition which hinders water from underneath to get out.

Surprisingly, the mineral wool products prepared by the method according to the present invention for the use of binders including gelatins are very heat resistant. The present inventors have found that in some embodiments the mineral wool products can sustain temperatures of up to 250° C. without degradation.

In one embodiment, the method according to the present invention is carried out such that the at least one protein is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin; proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; polyphenolic proteins such as mussel foot protein.

In one embodiment, the method according to the present invention is carried out such that the binder composition comprises at least two proteins, wherein one protein is at least one selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin, such as mussel foot protein; and another protein is at least one protein selected from group of proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques.

In one embodiment, the method according to the present invention is carried out with the proviso that the aqueous binder composition does not comprise a protein from soybeans (soy protein).

In one embodiment, the method according to the present invention is carried out such that the protein contains 50 to 400, such as 100 to 300 (hydroxy proline+proline) residues per 1000 amino acid residues.

In one embodiment, the method according to the present invention is carried out such that the binder composition further comprises an additive selected from the group of and oxidiser, such as tyrosinase, a pH-adjuster, preferably in form of a base, such as organic base, such as amine or salts thereof, inorganic bases, such as lithium hydroxide and/or sodium hydroxide and/or potassium hydroxide, such as in an amount of 0.01 to 10 wt. %, such as 0.05 to 6 wt. %, based on the combined dry weight of phenol containing compound and protein, such as ammonia or salts thereof.

In one embodiment, the method according to the present invention is carried out such that the binder composition has a pH of 4.5 to 9.5, such as 6.0 to 8.0.

Phenol containing compound component of the binder

In one embodiment, the method according to the present invention is characterized in that the binder composition used for the method additionally comprises at least one phenol containing compound, in particular one or more phenolic compounds.

Phenolic compounds, or phenolics, are compounds that have one or more hydroxyl group attached directly to an aromatic ring. Polyphenols (or polyhydroxyphenols) are compounds that have more than one phenolic hydroxyl group attached to one or more aromatic rings. Phenolic compounds are characteristic of plants and as a group they are usually found as esters or glycosides rather than as free compounds.

The term phenolics covers a very large and diverse group of chemical compounds.

Preferably, the phenol containing compound is a compound according to the scheme based on the number of carbons in the molecule as detailed in by W. Vermerris, R. Nicholson, in Phenolic Compound Biochemistry, Springer Netherlands, 2008.

In one embodiment, the phenol containing compound comprises a phenol containing compound such as simple phenolics, such as hydroxybenzoic acids, such as hydroxybenzoic aldehydes, such as hydroxyacetophenones, such as hydroxyphenylacetic acids, such as cinnamic acids, such as cinnamic acid esters, such as cinnamyl aldehydes, such as cinnamyl alcohols, such as coumarins, such as isocoumarins, such as chromones, such as flavonoids, such as chalcones, such as dihydrochalcones, such as aurones, such as flavanones, such as flavanonols, such as flavans, such as leucoanthocyanidins, such as flavan-3-ols, such as flavones, such as anthocyanidins, such as deoxyanthocyanidines, such as anthocyanins, such as biflavonyls, such as benzophenones, such as xanthones, such as stilbenes, such as betacyanins, such as polyphenols and/or polyhydroxyphenols, such as lignans, neolignans (dimers or oligomers from coupling of monolignols such as p-coumaryl alcohol, coniferyl alcohol and sinapyl alcohol), such as lignins (synthesized primarily from the monolignol precursors p-coumaryl alcohol, coniferyl alcohol and sinapyl alcohol), such as tannins, such as tannates (salts of tannins), such as condensed tannins (proanthocyanidins), such as hydrolysable tannins, such as gallotannins, such as ellagitannins, such as complex tannins, such as tannic acid, such as phlobabenes, such as phlorotannins, such as sulfonated phenolic containing compounds.

In one embodiment, the phenol containing compound is selected from the group consisting of simple phenolics, phenol containing compounds with a more complex structure than a C structure, such as oligomers of simple phenolics, polyphenols, and/or polyhydroxyphenols.

The phenol containing compounds according to the method of the present invention can also be synthetic or semisynthetic molecules or constructs that contain phenols, polyphenols. An example for such a construct is a protein, peptide, peptoids (such as linear and/or cyclic oligomers and/or polymers of N-substituted glycines, N-substituted p-alanines), or arylopeptoids (such as linear and/or cyclic oligomers and/or polymers of N-substituted aminomethyl benzamides) modified with phenol containing side chains. A dendrimer decorated with phenol containing side chains is another example.

In one embodiment, the phenol containing compound according to the method of the present invention is a quinone. Quinones are oxidized derivatives of aromatic compounds and are often readily made from reactive aromatic compounds with electron-donating substituents such as phenolics. Quinones useful for the present invention include benzoquinones, napthoquinone, anthraquinone and lawsone.

Tannins comprise a group of compounds with a wide diversity in structure that share their ability to bind and precipitate proteins. Tannins are abundant in many different plant species, in particular oak, chestnut, staghorn sumac and fringe cups. Tannins can be present in the leaves, bark and fruits. Tannins can be classified into three groups: condensed tannins, hydrolysable tannins and complex tannins. Condensed tannins, or proanthocyanidins, are oligomeric or polymeric flavonoids consisting of flavan-3-ol (catechin) units. Gallotannins are hydrolysable tannins with a polyol core substituted with 10-12 gallic acid residues. The most commonly found polyol in gallotannins is D-glucose although some gallotannins contain catechin and triterpenoid units as the core polyol. Ellagitanins are hydrolysable tannins that differ from gallotannins in that they contain additional C—C bonds between adjacent galloyl moieties. Complex tannins are defined as tannins in which a catechin unit is bound glycosidically to either a gallotannin or an ellagitannin unit.

In one embodiment, the tannin is selected from one or more components from the group consisting of tannic acid, condensed tannins (proanthocyanidins), hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

The inventors have found that a wide range of such phenol containing compounds can be used in order to obtain binder compositions which can be used in the method according to the present invention with excellent results. Often, these phenol containing compound components are obtained from vegetable tissues and are therefore a renewable material. In some embodiments, the compounds are also non-toxic and non-corrosive. As a further advantage, these compounds are antimicrobial and therefore impart their antimicrobial properties to the mineral wool product bound by such a binder.

Method in which the binder comprises at least one divalent metal cation M²⁺ containing compound

The present inventors have surprisingly found that the method according to the present invention can be further improved when the binder comprises at least one divalent metal cation M²⁺ containing compound.

In one embodiment, the method according to the present invention comprises the steps of:
applying a binder comprising
at least one protein in an amount of ≥35 wt.-%, such as ≥40 wt.-%, such as ≥50 wt.-%, such as ≥70 wt.-%, based on the weight of the total binder component solids,
at least one phenol containing compound, and
at least one additive selected from the group consisting of silicone oils, silicone resins, mineral oils, plant oils, hydrolysed plant oils, paraffins, waxes, superhydrofobic coatings such as nano-particles, and any mixtures thereof,
and curing the binder composition at a temperature of 150° C.-250° C., such as ≥150° C.-250° C., such as 175° C.-225° C.,
wherein

the at least one phenol containing compound is a tannin is selected from one or more components from the group consisting of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus,

the at least one protein is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin; proteins from vegetable sources not comprising soybeans (soy protein), including proteins from algae, legumes, cereals, whole grains, nuts, seeds and fruits, like protein from buckwheat, oats, rye, millet, maize (corn), rice, wheat, bulgur, sorghum, amaranth, quinoa, lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; polyphenolic proteins such as mussel foot protein.

Reaction of the Binder Components

Without wanting to be bound to any particular theory, the present inventors believe that the reaction between the phenol containing compound and the protein at least partly relies on an oxidation of phenols to quinones followed by nucleophilic attack of amine and/or thiol groups from the protein which leads to a crosslinking and/or modification of the proteins by the phenol containing compounds.

Accordingly, it has been found that the inclusion of at least one divalent metal cation M²⁺ in the binder used in the method according to the present invention is particularly useful when the binder additionally comprises at least one phenol containing compound.

Without wanting to be bound by any particular theory, the present inventors believe that the improvement of the properties of the mineral wool products prepared by the method according to the present invention due to the presence of the divalent metal cation M²⁺ containing compound can be explained by a chelation-effect, in which the M²⁺ crosslinks negatively charge groups of the cured binder.

In one embodiment, the method according to the present invention is carried out such that the binder comprises at least one divalent metal cation M²⁺ containing compound.

In one embodiment, the method according to the present invention is carried out such that the at least one divalent metal cation M²⁺ containing compound comprises one or more divalent metal cations M²⁺ selected from the group of divalent cations of earth alkaline metals, Mn, Fe, Cu, Zn, Sn.

In one embodiment, the method according to the present invention is carried out such that the divalent metal cation containing compound comprises Ca²⁺.

In one embodiment, the method according to the present invention is carried out such that the binder composition comprises the at least one divalent metal cation compound in an amount of 0.1 wt. % to 10 wt. %, such as 0.2 wt. % to 8 wt. %, such as 0.3 wt. % to 5 wt. %, such as 0.4 wt. % to 4.3 wt. %, such as 1.0 wt. % to 4.3 wt. %, based on the combined dry weight of phenol containing compound and protein.

By providing at least one divalent metal cation M²⁺ containing compound and at least one monovalent metal cation M⁺ containing compound, the crosslinking effect can, according to the theory of the inventors, be modulated and the properties of the mineral wool products can be tailor-made.

Method in which the binder composition further comprises at least one fatty acid ester of glycerol

In one embodiment, the method according to the present invention employs a binder composition which comprises a component in form of at least one fatty acid ester of glycerol.

A fatty acid is a carboxylic acid with an aliphatic chain, which is either saturated or unsaturated.

Glycerol is a polyol compound having the IUPAC name propane-1,2,3-triol.

Naturally occurring fats and oils are glycerol esters with fatty acids (also called triglycerides).

For the purpose of the present invention, the term fatty acid ester of glycerol refers to mono-, di-, and tri-esters of glycerol with fatty acids.

While the term fatty acid can in the context of the present invention be any carboxylic acid with an aliphatic chain, it is preferred that it is carboxylic acid with an aliphatic chain having 4 to 28 carbon atoms, preferably of an even number of carbon atoms.

Preferably, the aliphatic chain of the fatty acid is unbranched.

In a preferred embodiment, the at least one fatty acid ester of glycerol is in form of a plant oil and/or animal oil. In the context of the present invention, the term “oil” comprises at least one fatty acid ester of glycerol in the form of oils or fats.

In a preferred embodiment, the at least one fatty acid ester of glycerol is a plant-based oil.

In a preferred embodiment, the at least one fatty acid ester of glycerol is in form of fruit pulp fats such as palm oil, olive oil, avocado oil; seed-kernel fats such as lauric acid oils, such as coconut oil, palm kernel oil, babassu oil and other palm seed oils, other sources of lauric acid oils; palmitic-stearic acid oils such as cocoa butter, shea butter, borneo tallow and related fats (vegetable butters); palmitic acid oils such as cottonseed oil, kapok and related oils, pumpkin seed oil, corn (maize) oil, cereal oils; oleic-linoleic acid oils such as sunflower oil, sesame oil, linseed oil, perilla oil, hempseed oil, teaseed oil, safflower and niger seed oils, grape-seed oil, poppyseed oil, leguminous oil such as soybean oil, peanut oil, lupine oil; cruciferous oils such as rapeseed oil, mustard seed oil; conjugated acid oils such as tung oil and related oils, oiticica oil and related oils; substituted fatty acid oils such as castor oil, chaulmoogra, hydnocarpus and gorli oils, vernonia oil; animal fats such as land-animal fats such as lard, beef tallow, mutton tallow, horse fat, goose fat, chicken fat; marine oils such as whale oil and fish oil.

In a preferred embodiment, the at least one fatty acid ester of glycerol is in form of a plant oil, in particular selected from one or more components from the group consisting of linseed oil, coconut oil, corn oil, canola oil, cottonseed oil, olive oil, palm oil, peanut oil (ground nut oil), rapeseed oil, including canola oil, safflower oil, sesame oil, soybean oil, sunflower oil.

In a preferred embodiment, the at least one fatty acid ester of glycerol is selected from one or more components from the group consisting of a plant oil having an iodine number in the range of approximately 136 to 178, such as a linseed oil having an iodine number in the range of approximately 136 to 178, a plant oil having an iodine number in the range of approximately 80 to 88, such as an olive oil having an iodine number in the range of approximately 80 to 88, a plant oil having an iodine number in the range of approximately 163 to 173, such as tung oil having an iodine number in the range of approximately 163 to 173, a plant oil having an iodine number in the range of approximately 7 to 10, such as coconut oil having an iodine number in the range of approximately 7 to 10, a plant oil having an iodine number in the range of approximately 140 to 170, such as hemp oil having an iodine number in the range of approximately 140 to 170, a plant oil having an iodine number in the range of approximately 94 to 120, such as a rapeseed oil having an iodine number in the range of approximately 94 to 120, a plant oil having an iodine number in the range of approximately 118 to 144, such as a sunflower oil having an iodine number in the range of approximately 118 to 144.

In one embodiment, the at least one fatty acid ester of glycerol is not of natural origin.

In one embodiment, the at least one fatty acid ester of glycerol is a modified plant or animal oil.

In one embodiment, the at least one fatty acid ester of glycerol comprises at least one trans-fatty acid.

In an alternative preferred embodiment, the at least one fatty acid ester of glycerol is in form of an animal oil, such as a fish oil.

In one embodiment, the binder results from the curing of a binder composition comprising gelatin, and wherein the binder composition further comprises a tannin selected from one or more components from the group consisting of tannic acid, sulfonated tannins, condensed tannins (proanthocyanidins), hydrolysable tannins, gallotannins, ellagitannins, complex tannins, and/or tannin originating from one or more of oak, chestnut, staghorn sumac and fringe cups, preferably tannic acid, and the binder composition further comprises at least one fatty acid ester of glycerol, such as at least one fatty acid ester of glycerol selected from one or more components from the group consisting of linseed oil, coconut oil, corn oil, canola oil, cottonseed oil, olive oil, palm oil, peanut oil (ground nut oil), rapeseed oil, including canola oil, safflower oil, sesame oil, soybean oil, sunflower oil.

The present inventors have found that the parameter for the fatty acid ester of glycerol used in the binders according to the present invention of the amount of unsaturation in the fatty acid can be used to distinguish preferred embodiments. The amount of unsaturation in fatty acids is usually measured by the iodine number (also called iodine value or iodine absorption value or iodine index). The higher the iodine number, the more C═C bonds are present in the fatty acid. For the determination of the iodine number as a measure of the unsaturation of fatty acids, we make reference to Thomas, Alfred (2012) “Fats and fatty oils” in Ullmann's Encyclopedia of industrial chemistry, Weinheim, Wiley-VCH.

In a preferred embodiment, the at least one fatty acid ester of glycerol comprises a plant oil and/or animal oil having an iodine number of ≥75, such as 75 to 180, such as ≥130, such as 130 to 180.

In an alternative preferred embodiment, the at least one fatty acid ester of glycerol comprises a plant oil and/or animal oil having an iodine number of ≤100, such as ≤25.

In one embodiment, the at least one fatty acid ester of glycerol is a drying oil. For a definition of a drying oil, see Poth, Ulrich (2012) “Drying oils and related products” in Ullmann's Encyclopedia of industrial chemistry, Weinheim, Wiley-VCH.

In one embodiment, the at least one fatty acid ester of glycerol is selected from one or more components from the group consisting of linseed oil, olive oil, tung oil, coconut oil, hemp oil, rapeseed oil, and sunflower oil.

Accordingly, the present inventors have found that particularly good results are achieved when the iodine number is either in a fairly high range or, alternatively, in a fairly low range. While not wanting to be bound by any particular theory, the present inventors assume that the advantageous properties inflicted by the fatty acid esters of high iodine number on the one hand and low iodine number on the other hand are based on different mechanisms. The present inventors assume that the advantageous properties of glycerol esters of fatty acids having a high iodine number might be due to the participation of the C═C double-bonds found in high numbers in these fatty acids in a crosslinking reaction, while the glycerol esters of fatty acids having a low iodine number and lacking high amounts of C═C double-bonds might allow a stabilization of the cured binder by van der Waals interactions. The present inventors assume that the polar end of glycerol esters of fatty acids interacts with polar areas of the at least one protein while non-polar ends interact with non-polar areas of the at least one protein.

In one embodiment, the method according to the present invention uses a binder composition, wherein the content of fatty acid ester of glycerol is 0.6 to 60, such as 0.5 to 40, such as 1 to 30, such as 1.5 to 16, such as 3 to 10, such as 4 to 7.5 wt.-% based on the dry weight of the at least one protein and the at least one phenol containing compound.

Additives

The method according to the present invention uses a binder composition for mineral fibres which comprises an additive selected from the group consisting of silicone oils, silicone resins, mineral oils, plant oils, hydrolysed plant oils, paraffins, waxes, superhydrofobic coatings such as nano-particles, and any mixtures thereof.

In one embodiment, the method according to the present invention uses a binder composition which comprises the additive selected from the group consisting of silicone oils, silicone resins, mineral oils, plant oils, hydrolysed plant oils, paraffins, waxes, superhydrofobic coatings such as nano-particles, and any mixtures thereof in an amount of 0.2 to 30 wt. %, such as 0.6 to 20 wt. %, based on the binder solids.

In one embodiment, the additive is selected from the group consisting of silicone oils and silicone resins and any mixtures thereof. In one embodiment, the method according to the present invention uses a binder composition which contains further additives.

In one embodiment, the silicone oil and/or silicone resin is selected from one or more reactive or nonreactive silicones and may be added to the binder. Preferably, the one or more reactive or nonreactive silicone is selected from the group consisting of silicone constituted of a main chain composed of organosiloxane residues, especially diphenylsiloxane residues, alkylsiloxane residues, preferably dimethylsiloxane residues, bearing at least one hydroxyl, acyl, carboxyl or anhydride, amine, epoxy or vinyl functional group capable of reacting with at least one of the constituents of the binder composition and is preferably present in an amount of 0.1-15 weight-%, preferably from 0.1-10 weight-%, more preferably 0.3-8 weight-%, based on the total binder mass.

As already described above, many phenol containing compounds, in particular polyphenols, have antimicrobial properties and therefore impart antimicrobial characteristic to the binder. Nevertheless, in one embodiment, an anti-fouling agent may be added to the binder compositions.

In one embodiment, an anti-swelling agent may be added to the binder, such as tannic acid and/or tannins.

In one embodiment, the binder composition used in the method according to the present invention contains further additives in form of amine linkers and/or thiol/thiolate linkers. These additives in form of amine linkers and/or thiol/thiolate linkers are particular useful when the crosslinking reaction of the binder proceeds via the quinone-amine and/or quinone-thiol pathway.

In one embodiment, the binder compositions used in the method according to the present invention contain further additives in form of additives selected from the group consisting of PEG-type reagents, silanes, fatty acid esters of glycerol, and hydroxyl apatites.

Oxidising agents as additives can serve to increase the oxidising rate of the phenolics. One example is the enzyme tyrosinase which oxidizes phenols to hydroxyphenols/quinones and therefore accelerates the binder forming reaction.

In another embodiment, the oxidising agent is oxygen, which is supplied to the binder.

In one embodiment, the curing is performed in oxygen-enriched surroundings.

A mineral wool product comprising mineral wool fibres bound by a binder

The present invention is also directed to a mineral wool product bound by a binder resulting from the method according to the present invention described.

In one embodiment, the mineral wool product bound by a binder resulting from the method according to the present invention is characterized in that it has a water absorption of ≤5 kg/m², such as ≤2 kg/m², such as ≤1 kg/m².

In a preferred embodiment, the density of the mineral wool product is in the range of 10-1200 kg/m³, such as 30-800 kg/m³, such as 40-600 kg/m³, such as 50-250 kg/m³, such as 60-200 kg/m³.

In a preferred embodiment, the mineral wool product according to the present invention is an insulation product, in particular having a density of 10 to 200 kg/m³.

In an alternative embodiment, the mineral wool product according to the present invention is a facade panel, in particular having a density of 1000-1200 kg/m³.

In a preferred embodiment, the mineral wool product according to the present invention is an insulation product.

In a preferred embodiment, the loss on ignition (LOI) of the mineral wool product according to the present invention is within the range of 0.1 to 25.0%, such as 0.3 to 18.0%, such as 0.5 to 12.0%, such as 0.7 to 8.0% by weight.

In one embodiment the mineral wool product is a mineral wool insulation product, such as a mineral wool thermal or acoustical insulation product.

In one embodiment the mineral wool product is a horticultural growing media.

Further details on the method of producing a mineral wool product

The present invention provides a method of producing a mineral wool product by binding mineral fibres with the binder composition.

In one embodiment, the binder is supplied in the close vicinity of the fibre forming apparatus, such as a cup spinning apparatus or a cascade spinning apparatus, in either case immediately after the fibre formation. The fibres with applied binder are thereafter conveyed onto a conveyor belt as a web, such as a collected web.

The web, such as a collected web may be subjected to longitudinal or length compression after the fibre formation and before substantial curing has taken place.

Fibre Forming Apparatus

There are various types of centrifugal spinners for fiberizing mineral melts.

A conventional centrifugal spinner is a cascade spinner which comprises a sequence of a top (or first) rotor and a subsequent (or second) rotor and optionally other subsequent rotors (such as third and fourth rotors). Each rotor rotates about a different substantially horizontal axis with a rotational direction opposite to the rotational direction of the or each adjacent rotor in the sequence. The different horizontal axes are arranged such that melt which is poured on to the top rotor is thrown in sequence on to the peripheral surface of the or each subsequent rotor, and fibres are thrown off the or each subsequent rotor, and optionally also off the top rotor.

In one embodiment, a cascade spinner or other spinner is arranged to fiberize the melt and the fibres are entrained in air as a cloud of the fibres.

Many fibre forming apparatuses comprise a disc or cup that spins around a substantially vertical axis. It is then conventional to arrange several of these spinners in-line, i.e. substantially in the first direction, for instance as described in GB-A-926,749, US-A-3,824,086 and WO-A-83/03092.

There is usually a stream of air associated with the one or each fiberizing rotor whereby the fibres are entrained in this air as they are formed off the surface of the rotor.

In one embodiment, binder and/or additives is added to the cloud of fibres by known means. The amount of binder and/or additive may be the same for each spinner or it may be different.

In one embodiment, a hydrocarbon oil may be added into the cloud of fibres.

As used herein, the term “collected web” is intended to include any mineral fibres that have been collected together on a surface, i.e. they are no longer entrained in air, e.g. the fiberized mineral fibres, granulate, tufts or recycled web waste. The collected web could be a primary web that has been formed by collection of fibres on a conveyor belt and provided as a starting material without having been cross-lapped or otherwise consolidated.

Alternatively, the collected web could be a secondary web that has been formed by cross-lapping or otherwise consolidating a primary web. Preferably, the collected web is a primary web.

In one embodiment the mixing of the binder with the mineral fibres is done after the provision of the collected web in the following steps:
subjecting the collected web of mineral fibres to a disentanglement process,
suspending the mineral fibres in a primary air flow,
mixing binder composition with the mineral fibres before, during or after the disentanglement process to form a mixture of mineral fibres and binder.

A method of producing a mineral wool product comprising the process step of disentanglement is described in EP10190521, which is incorporated by reference.

In one embodiment, the disentanglement process comprises feeding the collected web of mineral fibres from a duct with a lower relative air flow to a duct with a higher relative air flow. In this embodiment, the disentanglement is believed to occur, because the fibres that enter the duct with the higher relative air flow first are dragged away from the subsequent fibres in the web. This type of disentanglement is particularly effective for producing open tufts of fibres, rather than the compacted lumps that can result in an uneven distribution of materials in the product.

According to a particularly preferred embodiment, the disentanglement process comprises feeding the collected web to at least one roller which rotates about its longitudinal axis and has spikes protruding from its circumferential surface. In this embodiment, the rotating roller will usually also contribute at least in part to the higher relative air flow. Often, rotation of the roller is the sole source of the higher relative air flow.

In preferred embodiments, the mineral fibres and optionally the binder are fed to the roller from above. It is also preferred for the disentangled mineral fibres and optionally the binder to be thrown away from the roller laterally from the lower part of its circumference. In the most preferred embodiment, the mineral fibres are carried approximately 180 degrees by the roller before being thrown off.

The binder may be mixed with the mineral fibres before, during or after the disentanglement process. In some embodiments, it is preferred to mix the binder with the fibres prior to the disentanglement process. In particular, the fibres can be in the form of an uncured collected web containing binder.

It is also feasible that the binder be pre-mixed with a collected web of mineral fibres before the disentanglement process. Further mixing could occur during and after the disentanglement process. Alternatively, it could be supplied to the primary air flow separately and mixed in the primary air flow.

The mixture of mineral fibres and binder is collected from the primary air flow by any suitable means. In one embodiment, the primary air flow is directed into the top of a cyclone chamber, which is open at its lower end and the mixture is collected from the lower end of the cyclone chamber.

The mixture of mineral fibres and binder is preferably thrown from the disentanglement process into a forming chamber.

Having undergone the disentanglement process, the mixture of mineral fibres and binder is collected, pressed and cured. Preferably, the mixture is collected on a foraminous conveyor belt having suction means positioned below it.

In a preferred method according to the invention, the mixture of binder and mineral fibres, having been collected, is pressed and cured.

In a preferred method according to the invention, the mixture of binder and mineral fibres, having been collected, is scalped before being pressed and cured.

The method may be performed as a batch process, however according to an embodiment the method is performed at a mineral wool production line feeding a primary or secondary mineral wool web into the fibre separating process, which provides a particularly cost efficient and versatile method to provide composites having favourable mechanical properties and thermal insulation properties in a wide range of densities.

Further Details on the Curing Step

The web is cured by a chemical and/or physical reaction of the binder components.

In one embodiment, the curing takes place in a curing device.

In one embodiment the curing is carried out at temperatures from 150° C.-250° C., such as >150° C.-250° C., such as 175° C.-225° C.

The curing process may commence immediately after application of the binder to the fibres.

In one embodiment the curing process comprises cross-linking and/or water inclusion as crystal water.

In one embodiment the cured binder contains crystal water that may decrease in content and raise in content depending on the prevailing conditions of temperature, pressure and humidity.

In one embodiment the curing takes place in a conventional curing oven for mineral wool production operating at a temperature of from 150° C.-250° C., such as ≥150° C.-250° C., such as 175° C.-225° C.

In one embodiment the curing process comprises a drying process.

In a preferred embodiment, the curing of the binder in contact with the mineral fibers takes place in a heat press.

The curing of a binder in contact with the mineral fibers in a heat press has the particular advantage that it enables the production of high-density products.

In one embodiment the curing process comprises drying by pressure. The pressure may be applied by blowing air or gas to the mixture of mineral fibres and binder.

The blowing process may be accompanied by heating or cooling or it may be at ambient temperature.

In one embodiment the curing process takes place in a humid environment.

The humid environment may have a relative humidity RH of 60-99%, such as 70-95%, such as 80-92%. The curing in a humid environment may be followed by curing or drying to obtain a state of the prevalent humidity.

The mineral wool product can be in any conventional configuration, for instance a mat or slab, and can be cut and/or shaped (e.g. into pipe sections) before, during or after curing of the binder.

Mineral wool product comprising mineral fibres bound by a cured formaldehyde-free binder

The present invention is also directed to a mineral wool product comprising mineral fibres bound by a cured formaldehyde-free binder, wherein
the binder in its uncured state comprises
at least one protein in an amount of ≥35 wt.-%, such as ≥40 wt.-%, such as ≥50 wt.-%, such as ≥70 wt.-%, based on the weight of the total binder component solids, and
at least one additive selected from the group consisting of silicone oils, silicone resins, mineral oils, plant oils, hydrolysed plant oils, paraffins, waxes, superhydrofobic coatings such as nano-particles, and any mixtures thereof,
and the mineral wool product has a water absorption of ≤5 kg/m², such as ≤2 kg/m², such as ≤1 kg/m².

For the purpose of the present application, the term “formaldehyde free” is defined to characterize a mineral wool product where the emission is below 5 μg/m²/h of formaldehyde from the mineral wool product, preferably below 3 μg/m²/h. Preferably, the test is carried out in accordance with ISO 16000 for testing aldehyde emissions.

Protein Component of the Binder

Preferably, the protein component of the binder is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silkworms, such as sericin; proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; polyphenolic proteins such as mussel foot protein.

Collagen is a very abundant material in living tissue: It is the main component in connective tissue and constitutes 25-35% of the total protein content in mammals. Gelatin is derived from chemical degradation of collagen. Gelatin may also be produced by recombinant techniques. Gelatin is water soluble and has a molecular weight of 10.000 to 500.000 g/mol, such as 30.000 to 300.000 g/mol dependent on the grade of hydrolysis. Gelatin is a widely used food product and it is therefore generally accepted that this compound is totally non-toxic and therefore no precautions are to be taken when handling gelatin.

Gelatin is a heterogeneous mixture of single or multi-stranded polypeptides, typically showing helix structures. Specifically, the triple helix of type I collagen extracted from skin and bones, as a source for gelatin, is composed of two α1(I) and one α2(I) chains.

Gelatin solutions may undergo coil-helix transitions.

A type gelatins are produced by acidic treatment. B type gelatins are produced by basic treatment.

Chemical cross-links may be introduced to gelatin. In one embodiment, transglutaminase is used to link lysine to glutamine residues; in one embodiment,

glutaraldehyde is used to link lysine to lysine, in one embodiment, tannins are used to link lysine residues.

The gelatin can also be further hydrolysed to smaller fragments of down to 3000 g/mol.

On cooling a gelatin solution, collagen like helices may be formed. Gelatin may form helix structures.

In one embodiment, the cured binder comprising protein comprises helix structures.

In one embodiment, the at least one protein is a low strength gelatin, such as a gelatin having a gel strength of 30 to 125 Bloom.

In one embodiment, the at least one protein is a medium strength gelatin, such as a gelatin having a gel strength of 125 to 180 Bloom.

In one embodiment, the at least one protein is a high strength gelatin, such as a gelatin having a gel strength of 180 to 300 Bloom.

In a preferred embodiment, the gelatin is preferably originating from one or more sources from the group consisting of mammal, bird species, such as from cow, pig, horse, fowl, and/or from scales, skin of fish.

In one embodiment, urea may be added to the binder compositions according to the present invention. The inventors have found that the addition of even small amounts of urea causes denaturation of the gelatin, which can slow down the gelling, which might be desired in some embodiments. The addition of urea might also lead to a softening of the product.

The inventors have found that the carboxylic acid groups in gelatins interact strongly with trivalent and tetravalent ions, for example aluminum salts. This is especially true for type B gelatins which contain more carboxylic acid groups than type A gelatins.

The present inventors have found that in some embodiments, curing/drying of binder compositions according to the present invention including gelatin should not start off at very high temperatures.

The inventors have found that starting the curing at low temperatures may lead to stronger products. Without being bound to any particular theory, it is assumed by the inventors that starting curing at high temperatures may lead to an impenetrable outer shell of the binder composition which hinders water from underneath to get out.

Surprisingly, the mineral wool products according to the present invention for the use of binders including gelatins are very heat resistant. The present inventors have found that in some embodiments the mineral wool products can sustain temperatures of up to 250° C. without degradation.

In one embodiment, the at least one protein is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin, proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; polyphenolic proteins such as mussel foot protein.

In one embodiment, the mineral wool product is prepared with a binder composition which comprises at least two proteins, wherein one protein is at least one selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin; such as mussel foot protein and another protein is at least one protein selected from group of proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques.

In one embodiment, the mineral wool product is prepared with a binder composition with the proviso that the aqueous binder composition does not comprise a protein from soybeans (soy protein).

In one embodiment, protein contains 50 to 400, such as 100 to 300 (hydroxy proline+proline) residues per 1000 amino acid residues.

In one embodiment, the mineral wool product according to the present invention is prepared with a binder composition which further comprises an additive selected from the group of and oxidiser, such as tyrosinase, a pH-adjuster, preferably in form of a base, such as organic base, such as amine or salts thereof, inorganic bases, such as ammonia or salts thereof.

In one embodiment, the mineral wool product is prepared with a binder composition which has a pH of 4.5 to 9.5, such as 6.0 to 8.0.

Phenol containing compound component of the binder

In one embodiment, the mineral wool product according to the present invention is characterized in that the binder in its uncured state additionally comprises at least one phenol containing compound, in particular one or more phenolic compounds.

Phenolic compounds, or phenolics, are compounds that have one or more hydroxyl group attached directly to an aromatic ring. Polyphenols (or polyhydroxyphenols) are compounds that have more than one phenolic hydroxyl group attached to one or more aromatic rings. Phenolic compounds are characteristic of plants and as a group they are usually found as esters or glycosides rather than as free compounds.

The term phenolics covers a very large and diverse group of chemical compounds. Preferably, the phenol containing compound is a compound according to the scheme based on the number of carbons in the molecule as detailed in by W. Vermerris, R. Nicholson, in Phenolic Compound Biochemistry, Springer Netherlands, 2008.

In one embodiment, the phenol containing compound comprises a phenol containing compound such as simple phenolics, such as hydroxybenzoic acids, such as hydroxybenzoic aldehydes, such as hydroxyacetophenones, such as hydroxyphenylacetic acids, such as cinnamic acids, such as cinnamic acid esters, such as cinnamyl aldehydes, such as cinnamyl alcohols, such as coumarins, such as isocoumarins, such as chromones, such as flavonoids, such as chalcones, such as dihydrochalcones, such as aurones, such as flavanones, such as flavanonols, such as flavans, such as leucoanthocyanidins, such as flavan-3-ols, such as flavones, such as anthocyanidins, such as deoxyanthocyanidines, such as anthocyanins, such as biflavonyls, such as benzophenones, such as xanthones, such as stilbenes, such as betacyanins, such as polyphenols and/or polyhydroxyphenols, such as lignans, neolignans (dimers or oligomers from coupling of monolignols such as p-coumaryl alcohol, coniferyl alcohol and sinapyl alcohol), such as lignins (synthesized primarily from the monolignol precursors p-coumaryl alcohol, coniferyl alcohol and sinapyl alcohol), such as tannins, such as tannates (salts of tannins), such as condensed tannins (proanthocyanidins), such as hydrolysable tannins, such as gallotannins, such as ellagitannins, such as complex tannins, such as tannic acid, such as phlobabenes, such as phlorotannins, such as sulfonated phenolic containing compounds.

In one embodiment, the phenol containing compound is selected from the group consisting of simple phenolics, phenol containing compounds with a more complex structure than a C structure, such as oligomers of simple phenolics, polyphenols, and/or polyhydroxyphenols.

The phenol containing compounds can also be synthetic or semisynthetic molecules or constructs that contain phenols, polyphenols. An example for such a construct is a protein, peptide, peptoids (such as linear and/or cyclic oligomers and/or polymers of N-substituted glycines, N-substituted p-alanines), or arylopeptoids (such as linear and/or cyclic oligomers and/or polymers of N-substituted aminomethyl benzamides) modified with phenol containing side chains. A dendrimer decorated with phenol containing side chains is another example.

In one embodiment, the phenol containing compound is a quinone. Quinones are oxidized derivatives of aromatic compounds and are often readily made from reactive aromatic compounds with electron-donating substituents such as phenolics. Quinones useful for the present invention include benzoquinones, napthoquinone, anthraquinone and lawsone.

Tannins comprise a group of compounds with a wide diversity in structure that share their ability to bind and precipitate proteins. Tannins are abundant in many different plant species, in particular oak, chestnut, staghorn sumac and fringe cups. Tannins can be present in the leaves, bark and fruits. Tannins can be classified into three groups: condensed tannins, hydrolysable tannins and complex tannins. Condensed tannins, or proanthocyanidins, are oligomeric or polymeric flavonoids consisting of flavan-3-ol (catechin) units. Gallotannins are hydrolysable tannins with a polyol core substituted with 10-12 gallic acid residues. The most commonly found polyol in gallotannins is D-glucose although some gallotannins contain catechin and triterpenoid units as the core polyol.

Ellagitanins are hydrolysable tannins that differ from gallotannins in that they contain additional C—C bonds between adjacent galloyl moieties. Complex tannins are defined as tannins in which a catechin unit is bound glycosidically to either a gallotannin or an ellagitannin unit.

In one embodiment, the tannin is selected from one or more components from the group consisting of tannic acid, condensed tannins (proanthocyanidins), hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

The inventors have found that a wide range of such phenol containing compounds can be used with excellent results. Often, these phenol containing compound components are obtained from vegetable tissues and are therefore a renewable material.

In some embodiments, the compounds are also non-toxic and non-corrosive. As a further advantage, these compounds are antimicrobial and therefore impart their antimicrobial properties to the mineral wool product bound by such a binder.

Divalent metal cation M²⁺ containing compound

The present inventors have surprisingly found that the mineral wool product according to the present invention can be further improved when the binder comprises at least one divalent metal cation M²⁺ containing compound.

Reaction of the Binder Components

Without wanting to be bound to any particular theory, the present inventors believe that the reaction between the phenol containing compound and the protein at least partly relies on an oxidation of phenols to quinones followed by nucleophilic attack of amine and/or thiol groups from the protein which leads to a crosslinking of the proteins by the phenol containing compounds.

Accordingly, it has been found that the inclusion of at least one divalent metal cation M²⁺ in the binder is particularly useful when the binder additionally comprises at least one phenol containing compound.

Without wanting to be bound by any particular theory, the present inventors believe that the improvement of the properties of the mineral wool products due to the presence of the divalent metal cation M²⁺ containing compound can be explained by a chelation-effect, in which the M²⁺ crosslinks negatively charge groups of the cured binder.

In one embodiment, the binder comprises at least one divalent metal cation M²⁺ containing compound.

In one embodiment, the at least one divalent metal cation M²⁺ containing compound comprises one or more divalent metal cations M²⁺ selected from the group of divalent cations of earth alkaline metals, Mn, Fe, Cu, Zn, Sn.

In one embodiment, the divalent metal cation containing compound comprises Ca²⁺.

In one embodiment, the binder composition comprises the at least one divalent metal cation compound in an amount of 0.1 wt. % to 10 wt. %, such as 0.2 wt. % to 8 wt. %, such as 0.3 wt. % to 5 wt. %, such as 0.4 wt. % to 4.3 wt. %, such as 1.0 wt. % to 4.3 wt. %, based on the combined dry weight of phenol containing compound and protein.

By providing at least one divalent metal cation M²⁺ containing compound and at least one monovalent metal cation M⁺ containing compound, the crosslinking effect can, according to the theory of the inventors, be modulated and the properties of the mineral wool products can be tailor-made.

Mineral Wool Product which Further Comprises at Least One Fatty Acid Ester of Glycerol

In one embodiment, the mineral wool product according to the present invention uses a binder composition which comprises a component in form of at least one fatty acid ester of glycerol.

A fatty acid is a carboxylic acid with an aliphatic chain, which is either saturated or unsaturated.

Glycerol is a polyol compound having the IUPAC name propane-1,2,3-triol.

Naturally occurring fats and oils are glycerol esters with fatty acids (also called triglycerides).

For the purpose of the present invention, the term fatty acid ester of glycerol refers to mono-, di-, and tri-esters of glycerol with fatty acids.

While the term fatty acid can in the context of the present invention be any carboxylic acid with an aliphatic chain, it is preferred that it is carboxylic acid with an aliphatic chain having 4 to 28 carbon atoms, preferably of an even number of carbon atoms. Preferably, the aliphatic chain of the fatty acid is unbranched.

In a preferred embodiment, the at least one fatty acid ester of glycerol is in form of a plant oil and/or animal oil. In the context of the present invention, the term “oil” comprises at least one fatty acid ester of glycerol in the form of oils or fats.

In a preferred embodiment, the at least one fatty acid ester of glycerol is a plant-based oil.

In a preferred embodiment, the at least one fatty acid ester of glycerol is in form of fruit pulp fats such as palm oil, olive oil, avocado oil; seed-kernel fats such as lauric acid oils, such as coconut oil, palm kernel oil, babassu oil and other palm seed oils, other sources of lauric acid oils; palmitic-stearic acid oils such as cocoa butter, shea butter, borneo tallow and related fats (vegetable butters); palmitic acid oils such as cottonseed oil, kapok and related oils, pumpkin seed oil, corn (maize) oil, cereal oils; oleic-linoleic acid oils such as sunflower oil, sesame oil, linseed oil, perilla oil, hempseed oil, teaseed oil, safflower and niger seed oils, grape-seed oil, poppyseed oil, leguminous oil such as soybean oil, peanut oil, lupine oil; cruciferous oils such as rapeseed oil, mustard seed oil; conjugated acid oils such as tung oil and related oils, oiticica oil and related oils; substituted fatty acid oils such as castor oil, chaulmoogra, hydnocarpus and gorli oils, vernonia oil; animal fats such as land-animal fats such as lard, beef tallow, mutton tallow, horse fat, goose fat, chicken fat; marine oils such as whale oil and fish oil.

In a preferred embodiment, the at least one fatty acid ester of glycerol is in form of a plant oil, in particular selected from one or more components from the group consisting of coconut oil, corn oil, canola oil, cottonseed oil, olive oil, palm oil, peanut oil (ground nut oil), rapeseed oil, including canola oil, safflower oil, sesame oil, soybean oil, sunflower oil.

In a preferred embodiment, the at least one fatty acid ester of glycerol is selected from one or more components from the group consisting of a plant oil having an iodine number in the range of approximately 136 to 178, such as a linseed oil having an iodine number in the range of approximately 136 to 178, a plant oil having an iodine number in the range of approximately 80 to 88, such as an olive oil having an iodine number in the range of approximately 80 to 88, a plant oil having an iodine number in the range of approximately 163 to 173, such as tung oil having an iodine number in the range of approximately 163 to 173, a plant oil having an iodine number in the range of approximately 7 to 10, such as coconut oil having an iodine number in the range of approximately 7 to 10, a plant oil having an iodine number in the range of approximately 140 to 170, such as hemp oil having an iodine number in the range of approximately 140 to 170, a plant oil having an iodine number in the range of approximately 94 to 120, such as a rapeseed oil having an iodine number in the range of approximately 94 to 120, a plant oil having an iodine number in the range of approximately 118 to 144, such as a sunflower oil having an iodine number in the range of approximately 118 to 144.

In one embodiment, the at least one fatty acid ester of glycerol is not of natural origin.

In one embodiment, the at least one fatty acid ester of glycerol is a modified plant or animal oil.

In one embodiment, the at least one fatty acid ester of glycerol comprises at least one trans-fatty acid.

In an alternative preferred embodiment, the at least one fatty acid ester of glycerol is in form of an animal oil, such as a fish oil.

In one embodiment, the binder results from the curing of a binder composition comprising gelatin, and wherein the binder composition further comprises a tannin selected from one or more components from the group consisting of tannic acid, sulfonated tannins, condensed tannins (proanthocyanidins), hydrolysable tannins, gallotannins, ellagitannins, complex tannins, and/or tannin originating from one or more of oak, chestnut, staghorn sumac and fringe cups, preferably tannic acid, and the binder composition further comprises at least one fatty acid ester of glycerol, such as at least one fatty acid ester of glycerol selected from one or more components from the group consisting of coconut oil, corn oil, canola oil, cottonseed oil, olive oil, palm oil, peanut oil (ground nut oil), rapeseed oil, including canola oil, safflower oil, sesame oil, soybean oil, sunflower oil.

The present inventors have found that the parameter for the fatty acid ester of glycerol used in the binders according to the present invention of the amount of unsaturation in the fatty acid can be used to distinguish preferred embodiments. The amount of unsaturation in fatty acids is usually measured by the iodine number (also called iodine value or iodine absorption value or iodine index). The higher the iodine number, the more C═C bonds are present in the fatty acid. For the determination of the iodine number as a measure of the unsaturation of fatty acids, we make reference to Thomas, Alfred (2012) “Fats and fatty oils” in Ullmann's Encyclopedia of industrial chemistry, Weinheim, Wiley-VCH.

In a preferred embodiment, the at least one fatty acid ester of glycerol comprises a plant oil and/or animal oil having an iodine number of ≥75, such as 75 to 180, such as ≥130, such as 130 to 180.

In an alternative preferred embodiment, the at least one fatty acid ester of glycerol comprises a plant oil and/or animal oil having an iodine number of ≤100, such as ≤25.

In one embodiment, the at least one fatty acid ester of glycerol is a drying oil. For a definition of a drying oil, see Poth, Ulrich (2012) “Drying oils and related products” in Ullmann's Encyclopedia of industrial chemistry, Weinheim, Wiley-VCH.

In one embodiment, the at least one fatty acid ester of glycerol is selected from one or more components from the group consisting of linseed oil, olive oil, tung oil, coconut oil, hemp oil, rapeseed oil, and sunflower oil.

Accordingly, the present inventors have found that particularly good results are achieved when the iodine number is either in a fairly high range or, alternatively, in a fairly low range. While not wanting to be bound by any particular theory, the present inventors assume that the advantageous properties inflicted by the fatty acid esters of high iodine number on the one hand and low iodine number on the other hand are based on different mechanisms. The present inventors assume that the advantageous properties of glycerol esters of fatty acids having a high iodine number might be due to the participation of the C═C double-bonds found in high numbers in these fatty acids in a crosslinking reaction, while the glycerol esters of fatty acids having a low iodine number and lacking high amounts of C═C double-bonds might allow a stabilization of the cured binder by van der Waals interactions. The present inventors assume that the polar end of glycerol esters of fatty acids interacts with polar areas of the at least one protein while non-polar ends interact with non-polar areas of the at least one protein.

In one embodiment, the method according to the present invention uses a binder composition, wherein the content of fatty acid ester of glycerol is 0.6 to 60, such as 0.5 to 40, such as 1 to 30, such as 1.5 to 16, such as 3 to 10, such as 4 to 7.5 wt.-% based on the dry weight of the at least one protein and the at least one phenol containing compound.

Additives

The mineral wool product according to the present invention comprises mineral fibres bound by a cured binder, wherein the binder in its uncured state comprises at least one additive selected from the group consisting of silicone oils, silicone resins, mineral oils, plant oils, hydrolysed plant oils, paraffins, waxes, superhydrofobic coatings such as nano-particles, and any mixtures thereof, and the mineral wool product has a water absorption of ≤5 kg/m², such as ≤2 kg/m², such as ≤1 kg/m².

In one embodiment, the additive is selected from the group consisting of silicone oils and silicone resins and any mixtures thereof.

In one embodiment, the silicone oil and/or silicone resin is selected from one or more reactive or nonreactive silicones and may be added to the binder. Preferably, the one or more reactive or nonreactive silicone is selected from the group consisting of silicone constituted of a main chain composed of organosiloxane residues, especially diphenylsiloxane residues, alkylsiloxane residues, preferably dimethylsiloxane residues, bearing at least one hydroxyl, acyl, carboxyl or anhydride, amine, epoxy or vinyl functional group capable of reacting with at least one of the constituents of the binder composition and is preferably present in an amount of 0.1-15 weight-%, preferably from 0.1-10 weight-%, more preferably 0.3-8 weight-%, based on the total binder mass.

In one embodiment, the binder in its uncured state comprises at least one additive selected from the group consisting of silicone oils, silicone resins, mineral oils, plant oils, hydrolysed plant oils, paraffins, waxes, superhydrofobic coatings such as nano-particles, and any mixtures thereof, and the mineral wool product has a water absorption of ≤5 kg/m², such as ≤2 kg/m², such as ≤1 kg/m².

In one embodiment, the binder contains further additives.

As already described above, many phenol containing compounds, in particular polyphenols, have antimicrobial properties and therefore impart antimicrobial characteristic to the binder. Nevertheless, in one embodiment, an anti-fouling agent may be added to the binder compositions.

In one embodiment, an anti-swelling agent may be added to the binder, such as tannic acid and/or tannins.

In one embodiment, the binder contains further additives in form of amine linkers and/or thiol/thiolate linkers. These additives in form of amine linkers and/or thiol/thiolate linkers are particular useful when the crosslinking reaction of the binder proceeds via the quinone-amine and/or quinone-thiol pathway.

In one embodiment, the binder contains further additives in form of additives selected from the group consisting of PEG-type reagents, silanes, fatty acid esters of glycerol, and hydroxyl apatites.

Oxidising agents as additives can serve to increase the oxidising rate of the phenolics. One example is the enzyme tyrosinase which oxidizes phenols to hydroxyphenols/quinones and therefore accelerates the binder forming reaction.

In another embodiment, the oxidising agent is oxygen, which is supplied to the binder.

In one embodiment, the curing is performed in oxygen-enriched surroundings.

The Mineral Wool Product

In a preferred embodiment, the density of the mineral wool product is in the range of 10-1200 kg/m³, such as 30-800 kg/m³, such as 40-600 kg/m³, such as 50-250 kg/m³, such as 60-200 kg/m³.

In a preferred embodiment, the mineral wool product according to the present invention is an insulation product, in particular having a density of 10 to 200 kg/m³.

In an alternative embodiment, the mineral wool product according to the present invention is a facade panel, in particular having a density of 1000-1200 kg/m³.

In a preferred embodiment, the mineral wool product according to the present invention is an insulation product.

In a preferred embodiment, the loss on ignition (LOI) of the mineral wool product according to the present invention is within the range of 0.1 to 25.0%, such as 0.3 to 18.0%, such as 0.5 to 12.0%, such as 0.7 to 8.0% by weight.

In one embodiment the mineral wool product is a mineral wool insulation product, such as a mineral wool thermal or acoustical insulation product.

In one embodiment the mineral wool product is a horticultural growing media.

Further details on the method of producing a mineral wool product

The present invention provides a method of producing a mineral wool product by binding mineral fibres with the binder composition.

In one embodiment, the binder is supplied in the close vicinity of the fibre forming apparatus, such as a cup spinning apparatus or a cascade spinning apparatus, in either case immediately after the fibre formation. The fibres with applied binder are thereafter conveyed onto a conveyor belt as a web, such as a collected web.

The web, such as a collected web may be subjected to longitudinal or length compression after the fibre formation and before substantial curing has taken place.

Fibre Forming Apparatus

There are various types of centrifugal spinners for fiberizing mineral melts.

A conventional centrifugal spinner is a cascade spinner which comprises a sequence of a top (or first) rotor and a subsequent (or second) rotor and optionally other subsequent rotors (such as third and fourth rotors). Each rotor rotates about a different substantially horizontal axis with a rotational direction opposite to the rotational direction of the or each adjacent rotor in the sequence. The different horizontal axes are arranged such that melt which is poured on to the top rotor is thrown in sequence on to the peripheral surface of the or each subsequent rotor, and fibres are thrown off the or each subsequent rotor, and optionally also off the top rotor.

In one embodiment, a cascade spinner or other spinner is arranged to fiberize the melt and the fibres are entrained in air as a cloud of the fibres.

Many fibre forming apparatuses comprise a disc or cup that spins around a substantially vertical axis. It is then conventional to arrange several of these spinners in-line, i.e. substantially in the first direction, for instance as described in GB-A-926,749, US-A-3,824,086 and WO-A-83/03092.

There is usually a stream of air associated with the one or each fiberizing rotor whereby the fibres are entrained in this air as they are formed off the surface of the rotor.

In one embodiment, binder and/or additives is added to the cloud of fibres by known means. The amount of binder and/or additive may be the same for each spinner or it may be different.

In one embodiment, a hydrocarbon oil may be added into the cloud of fibres.

As used herein, the term “collected web” is intended to include any mineral fibres that have been collected together on a surface, i.e. they are no longer entrained in air, e.g. the fiberized mineral fibres, granulate, tufts or recycled web waste. The collected web could be a primary web that has been formed by collection of fibres on a conveyor belt and provided as a starting material without having been cross-lapped or otherwise consolidated.

Alternatively, the collected web could be a secondary web that has been formed by cross-lapping or otherwise consolidating a primary web. Preferably, the collected web is a primary web.

In one embodiment the mixing of the binder with the mineral fibres is done after the provision of the collected web in the following steps:
subjecting the collected web of mineral fibres to a disentanglement process,
suspending the mineral fibres in a primary air flow,
mixing binder composition with the mineral fibres before, during or after the disentanglement process to form a mixture of mineral fibres and binder.

A method of producing a mineral wool product comprising the process step of disentanglement is described in EP10190521, which is incorporated by reference.

In one embodiment, the disentanglement process comprises feeding the collected web of mineral fibres from a duct with a lower relative air flow to a duct with a higher relative air flow. In this embodiment, the disentanglement is believed to occur, because the fibres that enter the duct with the higher relative air flow first are dragged away from the subsequent fibres in the web. This type of disentanglement is particularly effective for producing open tufts of fibres, rather than the compacted lumps that can result in an uneven distribution of materials in the product.

According to a particularly preferred embodiment, the disentanglement process comprises feeding the collected web to at least one roller which rotates about its longitudinal axis and has spikes protruding from its circumferential surface. In this embodiment, the rotating roller will usually also contribute at least in part to the higher relative air flow. Often, rotation of the roller is the sole source of the higher relative air flow.

In preferred embodiments, the mineral fibres and optionally the binder are fed to the roller from above. It is also preferred for the disentangled mineral fibres and optionally the binder to be thrown away from the roller laterally from the lower part of its circumference. In the most preferred embodiment, the mineral fibres are carried approximately 180 degrees by the roller before being thrown off.

The binder may be mixed with the mineral fibres before, during or after the disentanglement process. In some embodiments, it is preferred to mix the binder with the fibres prior to the disentanglement process. In particular, the fibres can be in the form of an uncured collected web containing binder.

It is also feasible that the binder be pre-mixed with a collected web of mineral fibres before the disentanglement process. Further mixing could occur during and after the disentanglement process. Alternatively, it could be supplied to the primary air flow separately and mixed in the primary air flow.

The mixture of mineral fibres and binder is collected from the primary air flow by any suitable means. In one embodiment, the primary air flow is directed into the top of a cyclone chamber, which is open at its lower end and the mixture is collected from the lower end of the cyclone chamber.

The mixture of mineral fibres and binder is preferably thrown from the disentanglement process into a forming chamber.

Having undergone the disentanglement process, the mixture of mineral fibres and binder is collected, pressed and cured. Preferably, the mixture is collected on a foraminous conveyor belt having suction means positioned below it.

In a preferred method according to the invention, the mixture of binder and mineral fibres, having been collected, is pressed and cured.

In a preferred method according to the invention, the mixture of binder and mineral fibres, having been collected, is scalped before being pressed and cured.

The method may be performed as a batch process, however according to an embodiment the method is performed at a mineral wool production line feeding a primary or secondary mineral wool web into the fibre separating process, which provides a particularly cost efficient and versatile method to provide composites having favourable mechanical properties and thermal insulation properties in a wide range of densities.

Further Details on the Curing Step

The web is cured by a chemical and/or physical reaction of the binder components.

In one embodiment, the curing takes place in a curing device.

In one embodiment the curing is carried out at temperatures from 150° C.-250° C., such as >150° C.-250° C., such as 175° C.-225° C.

The curing process may commence immediately after application of the binder to the fibres.

In one embodiment the curing process comprises cross-linking and/or water inclusion as crystal water.

In one embodiment the cured binder contains crystal water that may decrease in content and raise in content depending on the prevailing conditions of temperature, pressure and humidity.

In one embodiment the curing takes place in a conventional curing oven for mineral wool production operating at a temperature of from 150° C.-250° C., such as ≥150° C.-250° C., such as 175° C.-225° C.

In one embodiment the curing process comprises a drying process.

In a preferred embodiment, the curing of the binder in contact with the mineral fibers takes place in a heat press.

The curing of a binder in contact with the mineral fibers in a heat press has the particular advantage that it enables the production of high-density products.

In one embodiment the curing process comprises drying by pressure. The pressure may be applied by blowing air or gas to the mixture of mineral fibres and binder.

The blowing process may be accompanied by heating or cooling or it may be at ambient temperature.

In one embodiment the curing process takes place in a humid environment.

The humid environment may have a relative humidity RH of 60-99%, such as 70-95%, such as 80-92%. The curing in a humid environment may be followed by curing or drying to obtain a state of the prevalent humidity.

The mineral wool product can be in any conventional configuration, for instance a mat or slab, and can be cut and/or shaped (e.g. into pipe sections) before, during or after curing of the binder.

Use of a Curing Step

The present invention is also directed to the of a curing step characterized by a curing temperature of 150° C.-250° C., such as ≥150° C.-250° C., such as 175° C.-225° C. in a method for producing a mineral wool product comprising mineral fibres bound by a cured formaldehyde free binder, wherein the binder in its uncured state comprises
at least one protein in an amount of ≥35 wt.-%, such as ≥40 wt.-%, such as 50 wt.-%, such as ≥70 wt.-%, based on the weight of the total binder component solids, and
at least one additive selected from the group consisting of silicone oils, silicone resins, mineral oils, plant oils, hydrolysed plant oils, paraffins, waxes, superhydrofobic coatings such as nano-particles, and any mixtures thereof.

The present inventors have surprisingly found that the use of a curing step with these curing temperatures can strongly improve the water absorption properties of a mineral wool product prepared from a protein based binder.

Accordingly, the present invention is also directed to the use described above for the improvement of the water absorption properties of a mineral wool product.

### Example

Binder Mixing

To a stirred solution of NaOH (0.4 kg) in water (60 kg) at ambient temperature was added tannin (6.2 kg; Quebracho Extract Indusol ATO, Otto Dille).

Stirring was continued until a deep-brown solution was obtained (pH 9.0).

A mixture of gelatin (125 kg; IMAGEL® LA, GELITA AG) in water (528 L) was stirred at approx. 50° C. until a clear solution was obtained (pH 5.1). Linseed oil (6.6 kg; Leinol Firnis, OLI-NATURA), sodium hydroxide (0.3 kg) and 40% silane (0.7 kg; Silquest VS 142, Momentive) were then added and stirring was continued at 50° C. (pH 6.3). The above tannin solution was then added and stirring was continued at 50° C. (pH 7.3). Alternatively, the components could be mixed in an in-line fashion.

Binder and Additive Dosing

The above binder mixture was diluted as appropriate/required with water and dosed to the cascade spinner. To decrease dust from the resulting stone wool product and to render the stone wool product suitably hydrophobic, impregnation oil (Process oil 815, Brenntag) and hydrophobizing agent (Silres 5140, Wacker) were each added in-line and/or separately in an amount that corresponds to 0.2% of the stone wool weight.

Curing

The stone wool product was cured with air heated to a temperature that resulted in an inner/surface temperature of the wool exiting the curing oven in the vicinity of 200° C.

Results

| | | | Mineral |
|---|---|---|---|
| | Norm/ | Specifi- | wool |
| Product properties | procedure | cations | product |
| LOI (%) | | — | 5.0 |
| Oil content (%) | | — | 0.22 |
| Compression strength 10% σ₁₀ (kPa) | EN 826 | ≥20 | 20 |
| Density (kg/m³) | EN 1602 | 80 | 83.3 |
| Delamination σₘₜ (kPa) | EN 1607 | ≥7.5 | 8.5 |
| Density (kg/m³) | EN 1602 | 80 | 81.3 |
| Water uptake (kg/m²) | EN 1609 | ≤1 | 0.95 |

1. A method for producing a mineral wool product, comprising:
contacting mineral fibres with a formaldehyde-free binder composition for mineral fibres, the formaldehyde-free binder composition comprising;
at least one protein in an amount of ≥35 wt.-%, or ≥40 wt.-%, or ≥50 wt.-%, or ≥70 wt.-%, based on a weight of total binder component solids, and
at least one additive selected from the group consisting of silicone oils and silicone resins, and any mixtures thereof, and
curing the binder composition at a temperature of 150° C.-250° C., or >150° C.-250° C., or 175° C.-225° C.

2. The method according to claim 2, further comprising:
making a melt of raw materials;
fibrerising the melt by a fibre forming apparatus to form the mineral fibres;
providing the mineral fibres in the form of a collected web;
mixing the binder composition with the mineral fibres before, during or after the provision of the collected web to form a mixture of the mineral fibres and the binder composition; and
curing the mixture of the mineral fibres and the binder composition.

3. The method according to claim 1, wherein the at least one protein is selected from the group consisting of proteins from animal sources, including collagen, gelatin, hydrolysed gelatin, protein from milk (casein, whey), and eggs; proteins from jellyfish; proteins produced by recombinant techniques; proteins from insects, such as silk worms, such as sericin; proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds; proteins produced by recombinant techniques; and polyphenolic proteins such as mussel foot protein.

4. The method according to claim 1, wherein:
the at least one protein of the binder composition in an uncured state comprises at least two proteins;
one of the at least two proteins is at least one protein selected from the group consisting of proteins from animal sources, including collagen, gelatin, hydrolysed gelatin, protein from milk (casein, whey), and eggs; proteins from jellyfish; proteins produced by recombinant techniques; proteins from insects, such as silk worms, such as sericin; and mussel foot protein; and
another of the at least two proteins is at least one protein selected from the group of proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, sunflower seeds, and proteins produced by recombinant techniques.

5. The method according to claim 1, wherein the binder composition in an uncured state does not comprise a protein from soybeans (soy protein).

6. The method according to claim 1, wherein the at least one protein contains 50 to 400, or 100 to 300 (hydroxy proline+proline) residues per 1000 amino acid residues.

7. The method according to claim 1, wherein the binder composition further comprises at least one phenol containing compound.

8. The method according to claim 7, wherein the at least one phenol containing compound comprises a phenol containing compound selected from the group consisting of simple phenolics, hydroxybenzoic acids, hydroxybenzoic aldehydes, hydroxyacetophenones, hydroxyphenylacetic acids, cinnamic acids, cinnamic acid esters, cinnamyl aldehydes, cinnamyl alcohols, coumarins, isocoumarins, chromones, flavonoids, chalcones, dihydrochalcones, aurones, flavanones, flavanonols, flavans, leucoanthocyanidins, flavan-3-ols, flavones, anthocyanidins, deoxyanthocyanidines, anthocyanins, biflavonyls, benzophenones, xanthones, stilbenes, betacyanins, polyphenols and/or polyhydroxyphenols, lignans, neolignans (dimers or oligomers from coupling of monolignols such as p-coumaryl alcohol, coniferyl alcohol and sinapyl alcohol), lignins (synthesized primarily from the monolignol precursors p-coumaryl alcohol, coniferyl alcohol and sinapyl alcohol), tannins, tannates (salts of tannins), condensed tannins (proanthocyanidins), hydrolysable tannins, gallotannins, ellagitannins, complex tannins, tannic acid, phlobabenes, phlorotannins, and sulfonated phenolic containing compounds.

9. The method according to any of the claim 8, wherein the tannin is selected from one or more components from the group consisting of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

10. The method according to claim 7, wherein the at least one phenol containing compound comprises one or more synthetic or semisynthetic molecules that contain phenols, polyphenols, such as a proteins, peptides, peptoids or arylopeptoids modified with phenol containing side chains, such as dendrimers decorated with phenol containing side chains.

11. The method according to claim 7, wherein a content of the at least one phenol containing compound in the binder composition in an uncured state, such as in form of tannin is 1 to 60 wt. %, or 2 to 60 wt. %, or 3 to 50 wt. %, or 4 to 40 wt. %, or 5 to 35 wt. %, or 2.5 to 15 wt. %, or 4 to 12 wt. %, based on dry protein basis.

12. The method according to claim 1, wherein the binder composition in an uncured state further comprises an additive selected from the group of an oxidiser, such as tyrosinase, a pH-adjuster, preferably in form of a base, such as organic base, such as amine or salts thereof, inorganic bases such as lithium hydroxide and/or sodium hydroxide and/or potassium hydroxide, such as in an amount of 0.01 to 10 wt. %, or 0.05 to 6 wt. %, based on a combined dry weight of the phenol containing compound and the at least one protein, such as ammonia or salts thereof.

13. The method according to claim 1, wherein the binder composition in an uncured state has a pH of 4.5 to 9.5, or 6.0 to 8.0.

14. The method according to claim 1, wherein the binder composition in an uncured state further comprises at least one divalent metal cation M²⁺ containing compound.

15. The method according to claim 14, wherein the at least one divalent metal cation M²⁺ containing compound comprises one or more divalent metal cations M²⁺ selected from the group of divalent cations of earth alkaline metals, Mn, Fe, Cu, Zn, Sn.

16. The method according to claim 14, wherein the divalent metal cation containing compound comprises Ca²⁺.

17. The method according to claim 1, wherein the binder composition in an uncured state further comprises the at least one divalent metal cation compound in an amount of 0.1 wt. % to 10 wt. %, or 0.2 wt. % to 8 wt. %, or 0.3 wt. % to 5 wt. %, or 0.4 wt. % to 4.3 wt. %, or 1.0 wt. % to 4.3 wt. %, based on a combined dry weight of the phenol containing compound and the at least one protein.

18. The method according to claim 1, wherein the binder composition in an uncured state further comprises at least one fatty acid ester of glycerol.

19. The method according to claim 18, wherein the at least one fatty acid ester of glycerol is selected from one or more components from the group consisting of linseed oil coconut oil, corn oil, canola oil, cottonseed oil, olive oil, palm oil, peanut oil (ground nut oil), rapeseed oil, including canola oil, safflower oil, sesame oil, soybean oil, and sunflower oil.

20. The method according to claim 18, wherein a content of the at least one fatty acid ester of glycerol is 0.6 to 60, or 0.5 to 40, or 1 to 30, or 1.5 to 16, or 3 to 10, or 4 to 7.5 wt.-% based on a dry weight of the at least one protein and the at least one phenol containing compound.

21-22. (canceled)

23. A mineral wool product comprising:
mineral fibres bound by a cured formaldehyde-free binder;
wherein the binder in an uncured state comprises;
at least one protein in an amount of ≥35 wt.-%, or ≥40 wt.-%, or ≥50 wt.-%, or ≥70 wt.-%, based on a weight of a total of binder component solids, and
at least one additive selected from the group consisting of silicone oils and silicone resins, and any mixtures thereof,
and the mineral wool product has a water absorption of ≤5 kg/m², or 2 kg/m², or ≤1 kg/m².

24. A mineral wool product according to claim 23, wherein the at least one protein is selected from the group consisting of proteins from animal sources, including collagen, gelatin, hydrolysed gelatin, and protein from milk (casein, whey), and eggs; proteins from jellyfish; proteins produced by recombinant techniques; proteins from insects, such as silk worms, such as sericin; proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds; proteins produced by recombinant techniques; and polyphenolic proteins such as mussel foot protein.

25. The mineral wool product according to claim 23, wherein:
the at least one protein of the binder in the uncured state comprises at least two proteins;
one of the at least two proteins is at least one protein selected from the group consisting of proteins from animal sources, including collagen, gelatin, hydrolysed gelatin, and protein from milk (casein, whey), eggs; proteins from jellyfish; proteins produced by recombinant techniques; proteins from insects, such as silk worms, such as sericin, such as mussel foot protein; and
another of the at least two proteins is at least one protein selected from the group of proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, sunflower seeds, and proteins produced by recombinant techniques.

26. The mineral wool product according to claim 23, wherein the binder in the uncured state does not comprise a protein from soybeans (soy protein).

27. The mineral wool product according to claim 23, wherein the protein contains 50 to 400, or 100 to 300 (hydroxy proline+proline) residues per 1000 amino acid residues.

28. The mineral wool product according to claim 23, wherein a content of the at least one protein in the binder in the uncured state is 1 to 99 wt. %, or 3 to 97 wt. %, or 5 to 95 wt. %, or 10 to 90 wt. %, or 10 to 80 wt. %, based on content of the at least one phenol containing compound and the at least one protein.

29. The mineral wool product according to claim 23, wherein the mineral wool product further comprises at least one phenol containing compound.

30. The mineral wool product according to claim 29, wherein the at least one phenol containing compound comprises a phenol containing compound selected from the group consisting of simple phenolics, hydroxybenzoic acids, hydroxybenzoic aldehydes, hydroxyacetophenones, hydroxyphenylacetic acids, cinnamic acids, cinnamic acid esters, cinnamyl aldehydes, cinnamyl alcohols, coumarins, isocoumarins, chromones, flavonoids, chalcones, dihydrochalcones, aurones, flavanones, flavanonols, flavans, leucoanthocyanidins, flavan-3-ols, flavones, anthocyanidins, deoxyanthocyanidines, anthocyanins, biflavonyls, benzophenones, xanthones, stilbenes, betacyanins, polyphenols and/or polyhydroxyphenols, lignans, neolignans (dimers or oligomers from coupling of monolignols such as p-coumaryl alcohol, coniferyl alcohol and sinapyl alcohol), lignins (synthesized primarily from the monolignol precursors p-coumaryl alcohol, coniferyl alcohol and sinapyl alcohol), tannins, tannates (salts of tannins), condensed tannins (proanthocyanidins), hydrolysable tannins, gallotannins, ellagitannins, complex tannins, tannic acid, phlobabenes, phlorotannins, and sulfonated phenolic containing compounds.

31. The mineral wool product according to claim 30, wherein the tannin is selected from one or more components from the group consisting of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

32. The mineral wool product according to claim 29, wherein the at least one phenol containing compound comprises one or more synthetic or semisynthetic molecules that contain phenols, polyphenols, such as a proteins, peptides, peptoids or arylopeptoids modified with phenol containing side chains, such as dendrimers decorated with phenol containing side chains.

33. The mineral wool product according to claim 29, wherein a content of the at least one phenol containing compound in the binder in the uncured state, such as in form of tannin, is 1 to 60 wt. %, or 2 to 60 wt. %, or 3 to 50 wt. %, or 4 to 40 wt. %, or 5 to 35 wt. %, or 2.5 to 15 wt. %, or 4 to 12 wt. %, based on dry protein basis.

34. The mineral wool product according to claim 23, wherein the binder in the uncured state further comprises an additive selected from the group of an oxidiser, such as tyrosinase, a pH-adjuster, preferably in form of a base, such as organic base, such as amine or salts thereof, inorganic bases, such as ammonia or salts thereof.

35. The mineral wool product according to claim 23, wherein the binder in the uncured state has a pH of 4.5 to 9.5, or 6.0 to 8.0.

36. The mineral wool product according to claim 23, wherein the binder in the uncured state further comprises at least one divalent metal cation M²⁺ containing compound.

37. The mineral wool product according to claim 36, wherein the at least one divalent metal cation M²⁺ containing compound comprises one or more divalent metal cations M²⁺ selected from the group of divalent cations of earth alkaline metals, Mn, Fe, Cu, Zn, Sn.

38. The mineral wool product according to claim 36, wherein the divalent metal cation containing compound comprises Ca²⁺.

39. The mineral wool product according to claim 36, wherein the binder in the uncured state comprises the at least one divalent metal cation compound in an amount of 0.1 wt. % to 10 wt. %, or 0.2 wt. % to 8 wt. %, or 0.3 wt. % to 5 wt. %, or 0.4 wt. % to 4.3 wt. %, or 1.0 wt. % to 4.3 wt. %, based on a combined dry weight of the phenol containing compound and the at least one protein.

40. The mineral wool product according to claim 23, wherein the binder in the uncured state further comprises at least one fatty acid ester of glycerol.

41. The mineral wool product according to claim 40, wherein the at least one fatty acid ester of glycerol is selected from one or more components from the group consisting of linseed oil, coconut oil, corn oil, canola oil, cottonseed oil, olive oil, palm oil, peanut oil (ground nut oil), rapeseed oil, including canola oil, safflower oil, sesame oil, soybean oil, and sunflower oil.

42. The mineral wool product according to claim 40, wherein a content of fatty acid ester of glycerol is 0.6 to 60, or 0.5 to 40, or 1 to 30, or 1.5 to 16, or 3 to 10, or 4 to 7.5 wt.-% based on a dry weight of the at least one protein and the at least one phenol containing compound

43. The mineral wool product according to claim 23, wherein the mineral wool product is prepared by a method which comprises the steps of:
contacting the mineral fibres with the binder in the uncured state, and
curing the binder composition at a temperature of 150° C.-250° C., or >150° C.-250° C., or 175° C.-225° C.

44. (canceled)
